(19) United States
(12) Patent Application Publication
(10) Pub. No.: US 2014/0288997 A1
(43) Pub. Date: Sep. 25, 2014

(54) SYSTEMS AND METHODS FOR MANAGING CONTRACTS BETWEEN A FINANCIAL INSTITUTION AND ITS VENDORS

(71) Applicant: Digital Comply, Inc., Elizabethtown, KY (US)

(72) Inventors: Kelli Schultz, Elizabethtown, KY (US); Dana Bowers, Elizabethtown, KY (US)

(73) Assignee: Digital Comply, Inc., Elizabethtown, KY (US)

(21) Appl. No.: 14/225,217

(22) Filed: Mar. 25, 2014

Related U.S. Application Data
(60) Provisional application No. 61/805,066, filed on Mar. 25, 2013.

(51) Int. Cl. G06Q 10/06

(52) U.S. Cl. CPC G06Q 10/0635
USPC 705/7.28

(57) ABSTRACT

Methods and systems are presented herein for managing contracts between a financial institution and its vendors, for preparation of associated vendor oversight reports, and for securing subscriptions for a financial institution/vendor relationship management system. In certain embodiments, the system provides a guided workflow-driven process for building a complete report for auditors and examiners. In certain embodiments, the system encourages subscriptions from financial institutions for a financial institution/vendor relationship management system.

### RELATED APPLICATIONS

This application claims priority to and the benefit of U.S. Provisional Patent Application No. 61/805,066, filed Mar. 25, 2013, titled “Systems and Methods for Managing Contracts Between a Financial Institution and Its Vendors,” the application is incorporated herein by reference in its entirety.

### FIELD OF THE INVENTION

This invention relates generally to systems and methods for managing client/vendor relationships. More particularly, in certain embodiments, the invention relates to systems and methods for managing contracts between a financial institution and its vendors and for preparation of associated vendor oversight reports.

### BACKGROUND

Financial institutions such as banks and credit unions are increasingly relying on third-party vendors to perform various important functions. While this improves efficiency and reduces cost for the financial institution, there are various risks posed by such outsourcing. A financial institution must establish a vendor oversight program to mitigate such risks, comply with various regulations, and pass examination by auditors.

The vendor management process has historically been disjointed, messy, and time-consuming A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

There is a need for a consolidated, efficient system for managing contracts between a financial institution and its vendors and for preparation of associated vendor oversight reports.

### SUMMARY

Methods and systems are presented herein for managing contracts between a financial institution and its vendors, for preparation of associated vendor oversight reports, and for securing subscriptions for a financial institution/vendor relationship management system.

In one aspect, the invention is directed to a computer-implemented method for managing contracts between a financial institution and its vendors, the method comprising the steps of: (a) providing, by a processor of a computing device, a first graphical user interface (e.g., main dashboard or vendor dashboard) configured to display, for a given financial institution, a listing of vendor products and, upon selection of a listed vendor product by a user, to display details regarding the selected vendor product; (b) providing, by the processor, a second graphical user interface (e.g., upload widget) configured to facilitate uploading, by the user, of one or more contracts (and/or other documents) associated with the selected vendor product (e.g., for archival in the cloud, or other decentralized or centralized storage/archival server); (c) providing, by the processor, a third graphical user interface (e.g., guided exam prep workflow, series of widgets) configured to guide a user in preparation of a vendor oversight report associated with the selected vendor product (e.g., or associated with multiple products from a selected vendor); and (d) displaying, by the processor, a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

In some embodiments, the method comprises determining, by the processor, whether one or more uploaded contracts associated with the selected vendor product has an upcoming critical date (e.g., renewal date), activating an alert if a threshold in relation to the critical date and current date is met (e.g., critical date is 6 months away, 3 months away, etc.), and displaying an alert widget corresponding to the activated alert.

In some embodiments, the method comprises providing, by the processor, a graphical user interface configured to display one or more prompts for user entry of one or more of the following items corresponding to a selected vendor product or an associated uploaded contract: a contract renewal deadline, a vendor benchmark, a risk rating, a performance rating, a performance comment, a status (e.g., In-Term, Renewal Negotiation, Auto-Renew, Cancelled, or Replace), and contact information (e.g., name, email address, phone number) of a collaborator. In some embodiments, the one or more items prompted for user entry comprises a performance rating and a performance comment associated with the selected vendor product, wherein the entered performance rating is received anonymously (e.g., without association with the user entering the rating) and is compiled in a set of performance ratings received for the given vendor product by a plurality of users, wherein the method comprises displaying a composite performance rating and/or a listing of one or more performance comments received from users of the given vendor product (e.g., wherein the plurality of users represent a plurality of financial institutions). In some embodiments, the method comprises displaying, by the processor, the composite performance rating and/or the listing of one or more performance comments received from users of the given vendor product and/or one or more corresponding products provided by one or more different vendors. In some embodiments, the method comprises displaying, by the processor, one or more of the following corresponding to a given performance comment: a “like” prompt, a “dislike” prompt, a flag to identify inappropriate content. In some embodiments, the method comprises displaying a listing of a plurality of performance comments received from users of the given vendor product, wherein the listing is ordered on the graphical user interface according to popularity (e.g., number of “likes” received for each of the performance comments).

In some embodiments, the method comprises providing a graphical communication portal (e.g., a ‘private message’ window) allowing a user to anonymously solicit a textual message regarding a given vendor product by the vendor and/or to anonymously solicit a textual message regarding a given performance rating or performance comment by the user who provided the given performance rating or performance comment.

In some embodiments, the method comprises storing the one or more contracts and/or other documents associated with the selected vendor product (e.g., in the cloud, or other decentralized or centralized storage/archival server), and displaying icons and/or text corresponding to a set of folders for organizing the documents associated with the selected vendor product. In some embodiments, the set of folders for organizing the documents associated with the selected vendor product comprises a compliance document folder with text indicating it contains compliance documents. In some embodiments, selection by the user of the compliance document folder results in presentation, by the processor, of a set of subfolders, wherein the set of subfolders comprises text indicating one or more of the following categories: Audit/IT, Business Continuity, Financial, Insurance, Miscellaneous, Policy, and Product Management.

In some embodiments, the one or more items prompted for user entry comprises contact information (e.g., name, email address, phone number) of one or more collaborators for the selected vendor product. In some embodiments, the method comprises restricting access to stored documents and/or other information (e.g., reminders, notes, emails, etc.) regarding the selected vendor product, and/or restricting ability to upload documents and/or other information (e.g., reminders, notes, emails, etc.) pertaining to the selected vendor product, to a group of collaborators at a given financial institution named for that vendor product.

In some embodiments, step (c) comprises providing, by the processor, a guided workflow configured to guide a user in preparation of a vendor oversight report associated with the selected vendor product, wherein the guided workflow comprises a series of widgets (e.g., where a widget is a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and/or a scroll bar) prompting entry (e.g., sequential entry) or upload of one or more of the following: (i) the risk level associated with the selected vendor product; (ii) a date of next regulatory exam (e.g., wherein the method provides, by the processor, one or more reminder notification emails to the user based on the date of next regulatory exam); (iii) a selection of agency(ies) that apply to the financial institution user (e.g., CFPBC, FDIC, FED, NCUA, OCC, e.g., wherein the method provides, by the processor, a format for and/or fillable content for the vendor oversight report based on the selected agency(ies)); (iv) documents for use in preparation of the vendor oversight report (e.g., wherein the method displays, by the processor, a listing of previously uploaded documents associated with the selected vendor product alongside a listing of suggested document types for inclusion in the vendor oversight report, said suggested document types identified based on the risk level associated with the selected vendor product, e.g., wherein the method provides a widget that facilitates, by the processor, a drag-and-drop by the user of items from the listing of uploaded documents onto a corresponding suggested document type to identify said uploaded document as a document of said type, for inclusion of the linked uploaded document in the vendor oversight report); (v) textual commentary regarding the selected vendor product and/or the vendor of the selected vendor product; and (vi) a request for assistance (e.g., assistance by a collaborator associated with the selected vendor product or by another worker at the financial institution of the user). In some embodiments, the guided workflow displays a current status of the vendor oversight report associated with the selected vendor product (e.g., Not Started, Waiting on expert, Waiting for documents, Skipped, In Progress, or Complete). In some embodiments, the guided workflow displays a visual checklist of documents the financial institution has received from the vendor regarding the selected vendor product, and documents remaining to be obtained from the vendor prior to completion of the vendor oversight report associated with the selected vendor product.

In some embodiments, the method is a computer-implemented method for managing contracts between a financial institution and its vendors and for preparation of associated vendor oversight reports as part of a financial institution/vendor relationship management system.

In some implementations, the method may include providing, by the processor, a graphical user interface configured to display one or more prompts for a user entry associated with a risk assessment of a given vendor product (e.g., wherein the given vendor product is related to at least one of Information Access, Operational and Financial Dependency, and Regulatory Exposure). The user entry may be in response to a set of questionnaires.

In some implementations, the graphical user interface may provide a dashboard that displays all of the existing risk-assessment evaluation and the completed risk-assessment evaluation performed by a given organization associated to an end-user. The graphical user interface may display a first list of vendor products having never had a risk assessment completed, a second list of vendor products having an annual risk assessment due, and a third list of vendor products that are currently being assessed or have been completed within the last year.

In some implementations, the method may include determining, by the processor, whether a request to initiate risk assessment for the given vendor product is a duplicate of an existing risk-assessment evaluation or a completed risk-assessment evaluation. The method may include preventing, by the processor, the request from initiating a new risk-assessment evaluation for the same product.

In another aspect, the invention is directed to a financial institution/vendor relationship management system for managing contracts between a financial institution and its vendors and for preparation of associated vendor oversight reports, the system comprising: a data management module configured to store data (e.g., documents and/or information) pertaining to a set of vendor products for a financial institution, said data accessible by a computing device (e.g., a portable computing device), the computing device comprising: a processor; and a non-transitory computer readable medium storing instructions thereon, wherein the instructions, when executed, cause the processor to: (a) provide a first graphical user interface (e.g., main dashboard or vendor dashboard) to display on the computing device, for a given financial institution, a listing of vendor products and, upon selection of a listed vendor product by a user via the computing device, to display details regarding the selected vendor product; (b) provide a second graphical user interface (e.g., an upload widget) on the computing device to facilitate uploading, by the user, of one or more contracts (and/or other documents) associated with the selected vendor product via the computing device (e.g., for archival in the cloud, or other decentralized or centralized storage/archival server); (c) provide a third graphical user interface (e.g., guided exam prep workflow, series of widgets) on the computing device to guide a user in preparation of a vendor oversight report associated with the selected vendor product (e.g., or associated with multiple products from a selected vendor); and (d) display on the computing device a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

In another aspect, the invention is directed to a method for securing subscriptions for a financial institution/vendor relationship management system for managing contracts between a financial institution and its vendors and for preparation of associated vendor oversight reports, the method comprising the steps of: (a) providing, by a processor of a computing device, a web-based graphical user interface that facilitates uploading by a vendor of compliance documentation; (b) displaying, by the processor, one or more widgets (e.g., where a widget is a window, a text box, a button, a hyperlink, a drop-down list, a list box, a combo box, a check box, a radio button, a cycle button, a data-grid, a spinner, a menu, a menu bar, a toolbar, an icon, a tree view, a grid view, a link, a tab, and/or a scroll bar) prompting secure upload (e.g., to the cloud, or other decentralized or centralized storage/archival server) of compliance documents associated with a given vendor product owned by a financial institution identified by the vendor and/or prompting entry, by the vendor, of one or more of: (i) compliance data, and (ii) financial institution contact information (e.g., email address) associated with the given vendor product; and (c) sending, by the processor, an email notification to the financial institution identified by the vendor that compliance data and/or compliance documents have been uploaded by the vendor, wherein the email notification comprises an invitation to the financial institution to enter into a subscription to retrieve the uploaded data and/or documents via the relationship management system. In some embodiments, the method comprises displaying, by the processor, an invitation to a user at the financial institution an offer to upgrade the subscription (e.g., where an initial subscription is free, and an upgrade is available to manage more than one vendor product and/or to expand available storage space for archival of uploaded data and/or documents corresponding to a vendor product. In some embodiments, the subscription includes use of the financial institution/vendor relationship management system.

The description of elements of the embodiments with respect to one aspect of the invention can be applied to another aspect of the invention as well. For example, features described in a claim depending from an independent method claim may be applied, in another embodiment, to an independent system claim.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is an example main dashboard in accordance with an embodiment of the invention.

FIG. 4 is an example vendor dashboard in accordance with an embodiment of the invention.

FIG. 5 is an example document storage page in accordance with an embodiment of the invention.

FIG. 6 is an example workflow of the system in guiding an end-user in preparing a vendor oversight report associated with one or more selected vendor products in accordance with an embodiment of the invention.

FIG. 7 is an example vendor exam preparation workspace in accordance with an embodiment of the invention.

FIG. 8 is an example workspace for collecting documents by matching collected end-user's document to a list of suggested documents in accordance with an embodiment of the invention.

FIG. 9 is an example workspace for collecting documents by prompting the end user for selection of actions for unassigned documents that have been provided by the end user in accordance with an embodiment of the invention.

FIG. 10 is an example workspace for collecting documents by prompting the end user for selection of actions for unassigned suggested documents in accordance with an embodiment of the invention.

FIG. 11 is an example workspace for preparing a collected document for the examination report in accordance with an embodiment of the invention.

FIG. 12 is an example workspace for uploading document to be attached and included in the examination in accordance with an embodiment of the invention.

FIG. 13 is an example workspace to previewing contents to be included in the examination report.

FIG. 14 is an example workspace to review vendor products in accordance with an embodiment of the invention.

FIG. 15 is an example display for viewing product review in accordance with an embodiment of the invention.

FIG. 16 is an example alert and information display in accordance with an embodiment of the invention.

FIG. 17 is an example workspace for performing a risk-assessment evaluation of a vendor product in accordance with an embodiment of the invention.

FIG. 18 is an example workspace to initiate a new risk assessment of a vendor product in accordance with an embodiment of the invention.

FIG. 19 is an example workspace to view risk assessments that are in-progress in accordance with an embodiment of the invention.

FIG. 20 is an example workspace to view completed risk-assessment evaluations in accordance with an embodiment of the invention.

FIG. 21 is an example dashboard to manage risk-assessment evaluation of vendors and vendor products in accordance with an embodiment of the invention.

FIG. 22 is an example risk-assessment workspace in accordance with an embodiment of the invention.

FIG. 23 is an example invitation-workspace 2300 to invite peers to contribute to a risk-assessment evaluation in accordance with an embodiment of the invention.

FIG. 24 is an example request-message for peer collaborative input for a given risk-assessment evaluation in accordance with an embodiment of the invention.

FIG. 25 is an exemplary cloud computing environment for use with the systems and methods described herein, in accordance with an illustrative embodiment.

FIG. 26 is an example of a computing device and a mobile computing device that can be used to implement the techniques described in this disclosure.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Methods and systems are presented herein for managing contracts between a financial institution and its vendors, for preparation of associated vendor oversight reports, and for securing subscriptions for a financial institution/vendor relationship management system.

In certain embodiments, a web-based system is provided for improved vendor contract management, enhanced collaboration within a financial institution, and organized, step-by-step vendor oversight report preparation. For example, the contract management feature allows financial institutions to store contracts, enter key terms and other information in order to set reminders and benchmark against like vendors. The collaboration feature allows multiple users of a given financial institution to store documentation, set reminders, make notes, upload emails, and the like, for purposes of managing various aspects of a vendor relationship, including day-to-day service management, accounts payable, and risk management. The vendor rate-and-review feature allows financial institutions to rate and review individual vendor products and see the ratings and reviews that other financial institutions have provided. In certain embodiments, a star rating system is employed, and open comments may be provided by name or anonymously. Inappropriate comments may be flagged, and listings of reviews may be ranked by popularity.

In certain embodiments, the examination preparation feature provides a guided workflow-driven process for building a complete report for auditors and examiners. It provides a process for matching risk ratings to suggested risk management content that a financial institution should review annually for at least their high-to-moderate risk vendors. Then, vendor documentation is matched to suggested content, creating a visual checklist of what the financial institution has received from the vendor and what they are missing and may still need to collect. This allows for general, more strategic level comments at the vendor and product level, and supports specific review of each document provided by the vendor. A financial institution user may invite an expert (from within the same financial institution) for help with complex document reviews such as IT audits or financials. Output is a compiled report of all financial institution comments, supporting documentation, and vendor documents.

Embodiments of the system architecturally bridge relationships between financial institutions and their vendors so that there is only ever a single instance of a given financial institution or vendor in the system. This allows aggregation of information for vendors providing similar products, financial institutions with similar characteristics, and provides for other synergies. There is a high degree of user-friendliness, because backbone data can be shared (e.g., primary financial institution and vendor records), without compromising private data that an individual financial institution or vendor enters that should not be exposed to others.

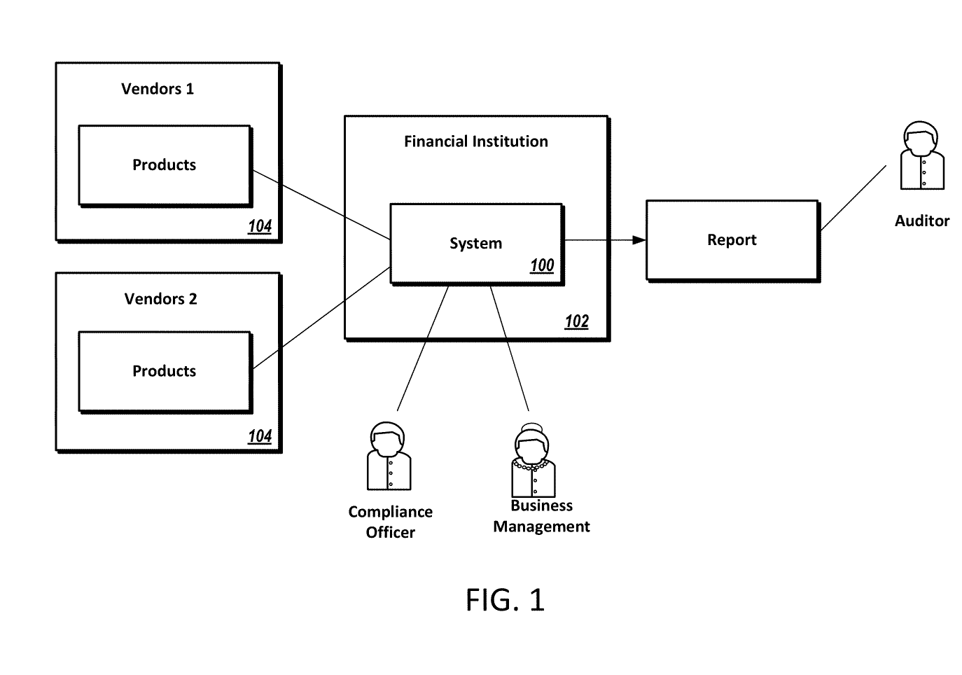

FIG. 1 is a block diagram of an example system 100 to assist financial institutions 102 to manage vendors 104 in accordance with an embodiment of the invention. In some implementations, the system 100 provides guided workflow i) to manage contracts with a given vendor 104, to provide a guided workflow to assist the financial institution 102 to prepare for an compliance or contract audit examination, ii) to provide a rating system of the vendors 104 and their products and services, iii) to provide a risk-assessment rating-system for the vendors 104, and iv) to provide mechanisms for collaboration, the tracking of communication, and document storage.

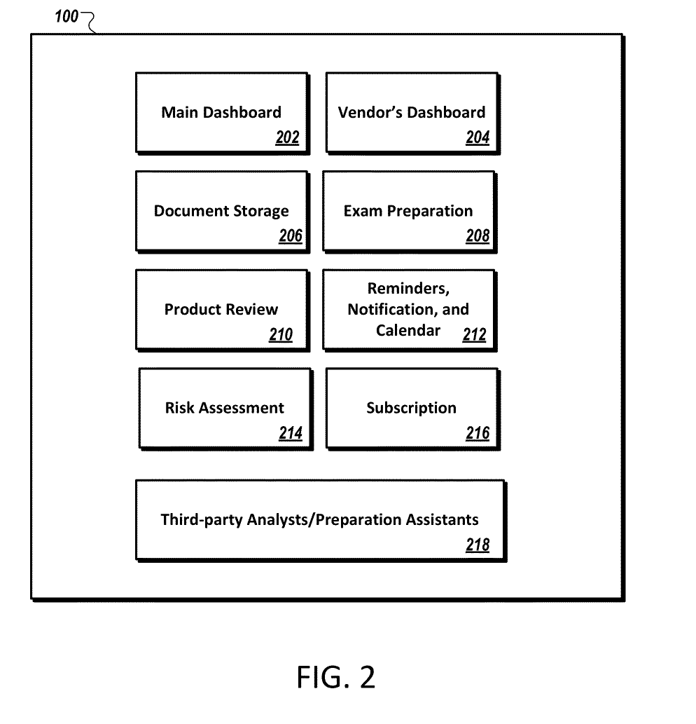

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system's components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

Main Dashboard

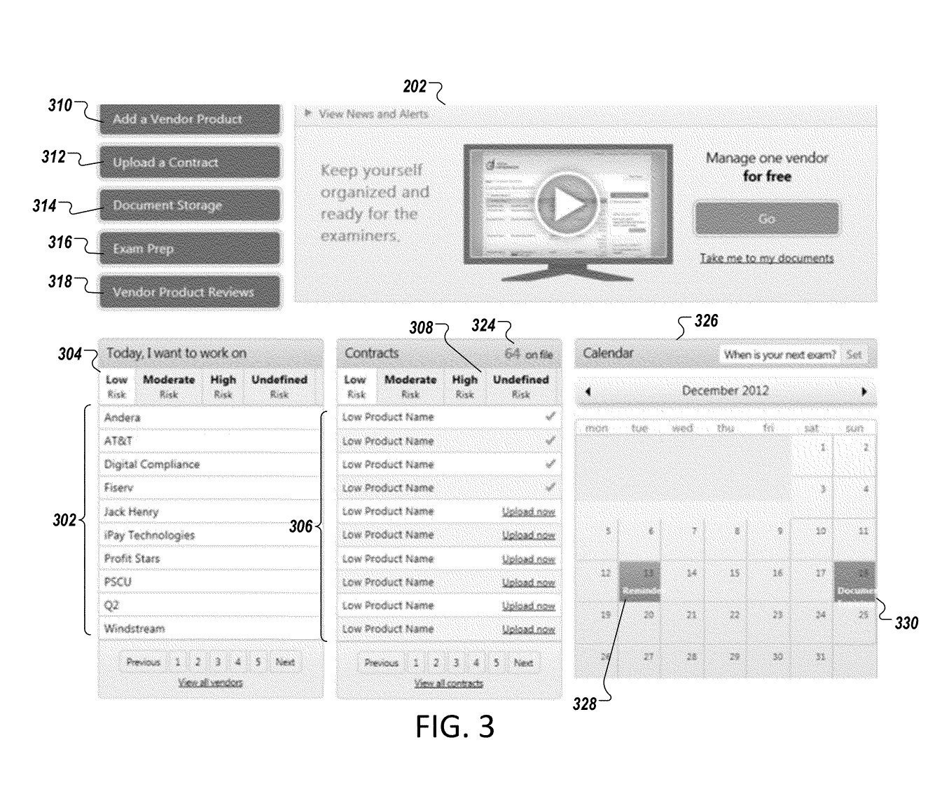

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintain within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

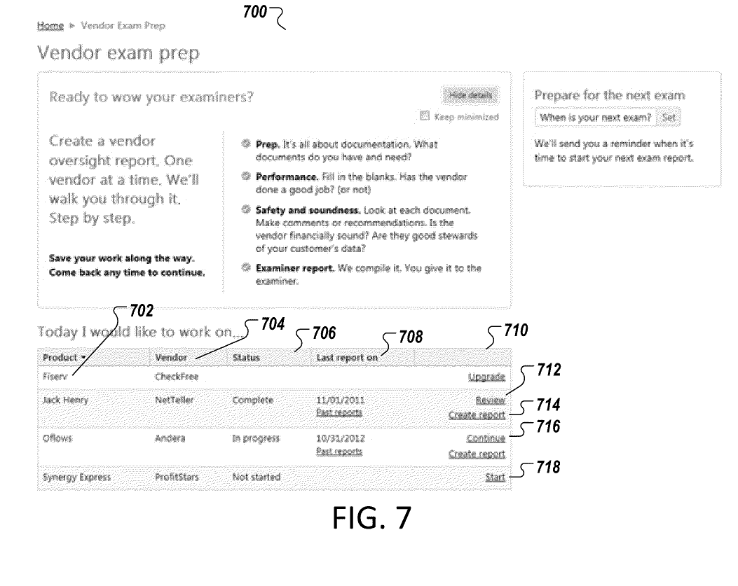

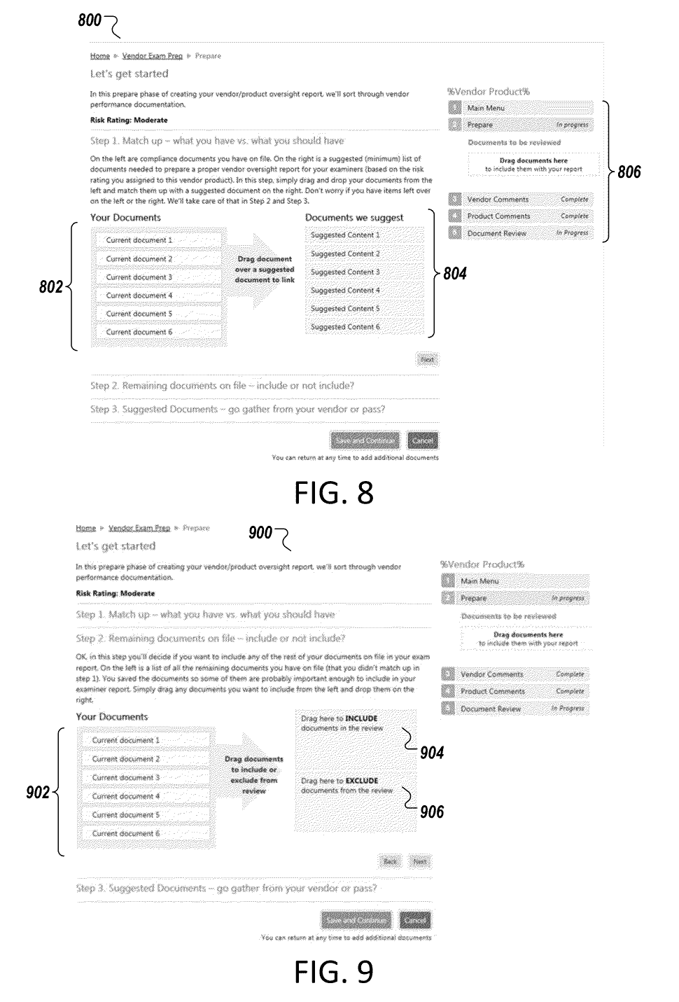

In some implementations, the risk-levels 304, 308 may be used to determine a suggested document 320 (see—see FIG. 8) in the examination-preparation area 322 (not shown—see FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

Vendor Dashboard

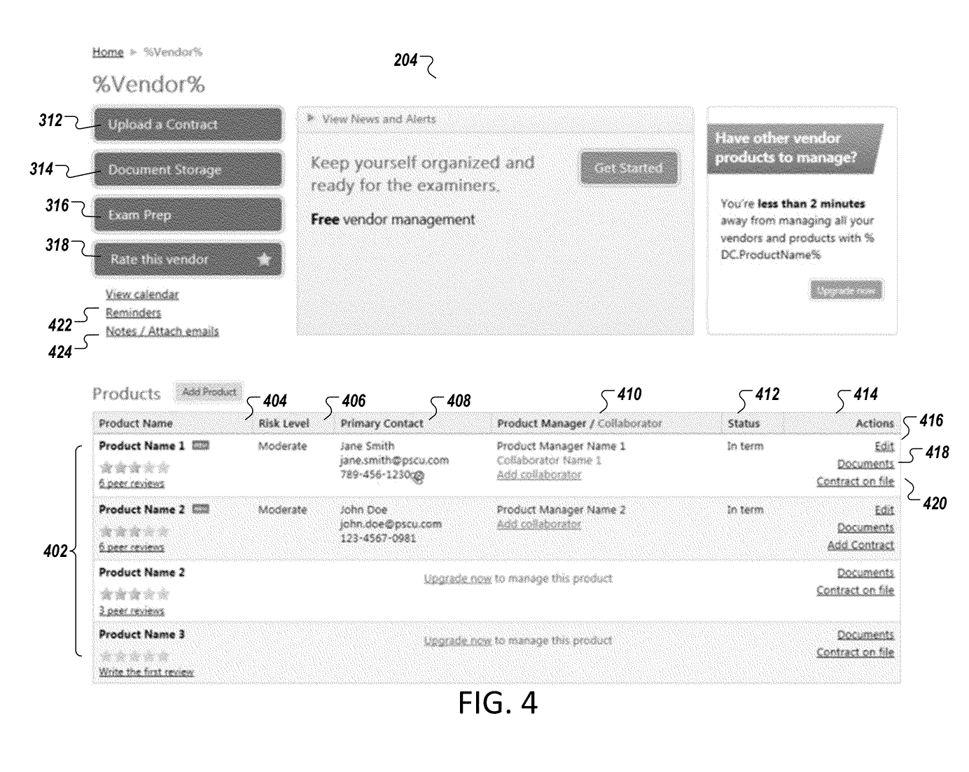

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reach | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/ | Sent on the expiration |
| | | documents associated | date |
| | | with the contract will | |
| | | also be in cancelled | |
| | | status and archived | |
| Replace | Financial Institution | Move old contract to | |
| | replacing the existing | archives/ new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

Document Storage

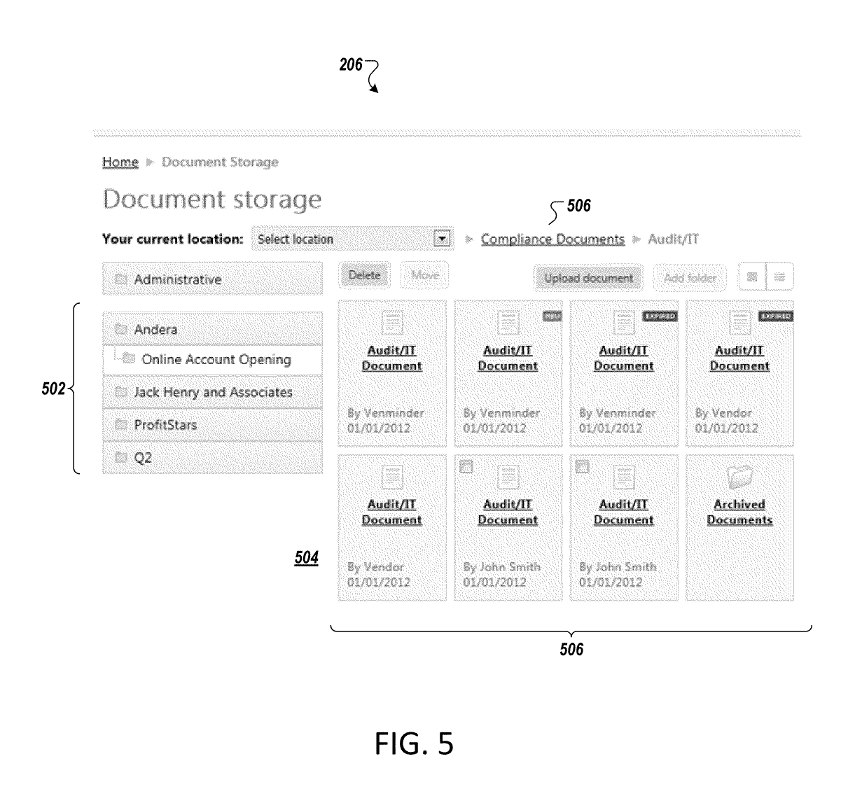

FIG. 5 is an example document storage page 206 in accordance with an embodiment of the invention. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

Exam Preparation

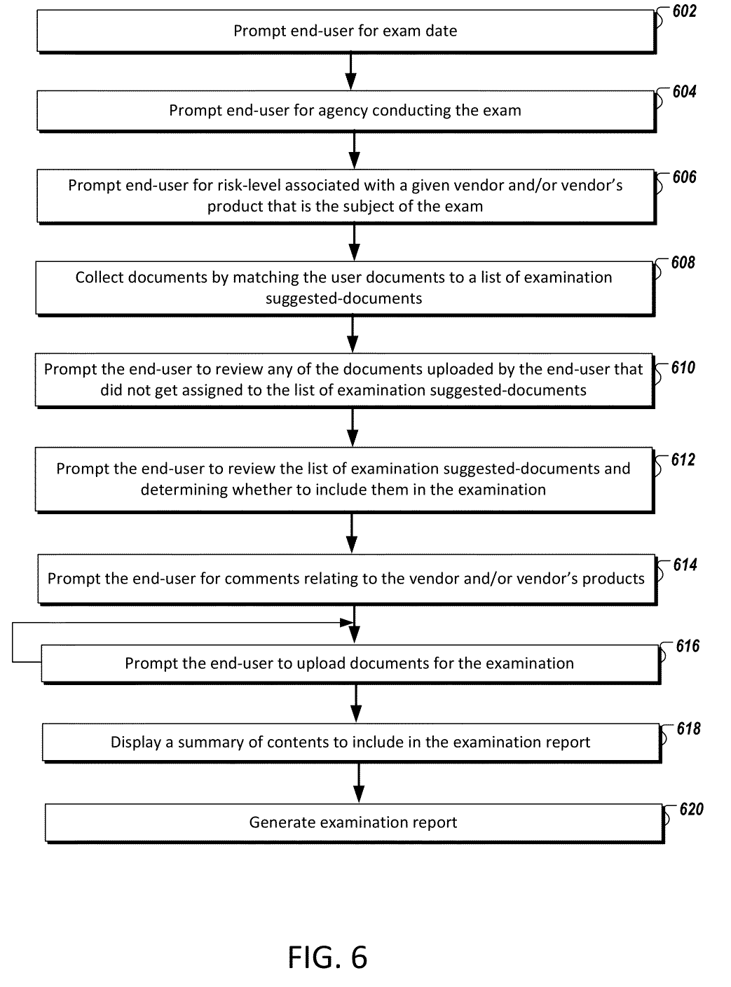

FIG. 6 is an example workflow of the system 100 to guide an end-user to prepare a vendor oversight report associated with one or more selected vendor products in accordance with an embodiment of the invention. The workflow may be referred to as “Exam Prep”. The Exam Prep may be used to assist and guide the users of a financial institutions to prepare, for example, for its annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notification (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an embodiment of the invention. The workspace 700 may display a list of products 702. For each of the products 702, the workspace 700 may display the vendor name (704), the status of the examination (706), the last reported date (708), and actionable tasks 710. The last reported date 708 may be, for example, the last time a report was created or the last time the product was examined. The status of the examination (706) may include “complete”, “in progress”, and “not started.” A list of the examination status is shown in Table 2.

TABLE 2

| Status | Description | Action |
|---|---|---|
| Complete | All steps have been completed | Review, Preview report |
| In progress | Started but not all steps | Continue, Preview report |
| | completed | |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined list. The pre-defined list may be selected based on the risk-level associated with the given product or vendor subject to the examination.

FIG. 8 is an example workspace 800 for matching collected end-user's document to a list of suggested documents in accordance with an embodiment of the invention. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-profess, or ready to start) in the workflow.

Referring back to FIG. 6, in some implementations, the method 600 may include prompting the end-user to review any of the collected documents uploaded by the end-user that was not assigned to the list of the examination suggested-documents (step 610). FIG. 9 is an example workspace 900 for prompting the end-user to review the unassigned documents 902 that has been collected to the document storage page 206, but has not been assigned in FIG. 8. In some implementations, the system 100 may prompt the end-user to identify each of the unassigned documents as either to include (904) or exclude (906) from the report/examination.

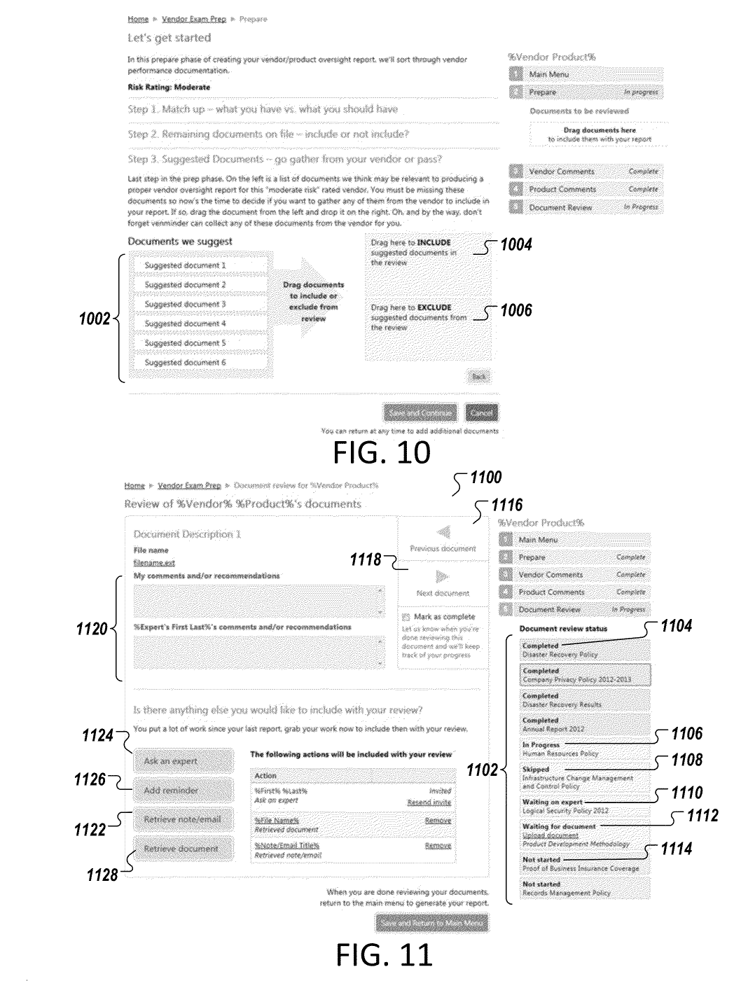

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor product that is being examined.

Still looking at FIG. 6, in some implementations, the method 600 may include displaying (step 614) all of the documents that has been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an embodiment of the invention. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document | |
|---|---|
| Status-Label | Description |
| Not Started | Included in exam but the user has not reviewed it |
| Waiting on expert | Expert has been invited but no response provided |
| Waiting for | Document type is included in exam but document |
| documents | has not been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. After which, the system 100 may only allow the co-worker and/or expert to view and provide comments for the vendors and/or vendor product to which they were asked for comments. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request for comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc), and an identity of the end-user and/or product manager that performed the uploaded. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may add documents to the examination preparation process from there.

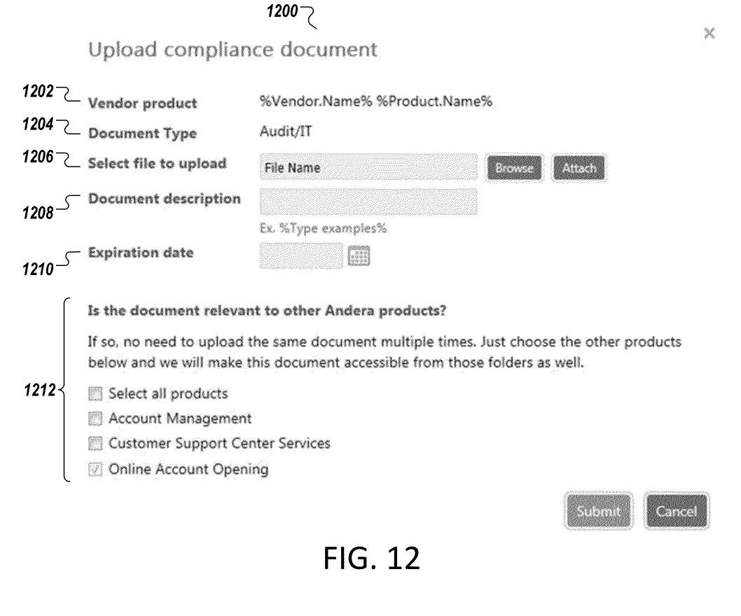

Referring back to FIG. 6, in some implementations, the method 600 may include prompting the end-user to upload documents for the examination (step 616). FIG. 12 is an example workspace 1200 for uploading document to be attached and included in the examination in accordance with an embodiment of the invention. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be include in the report.

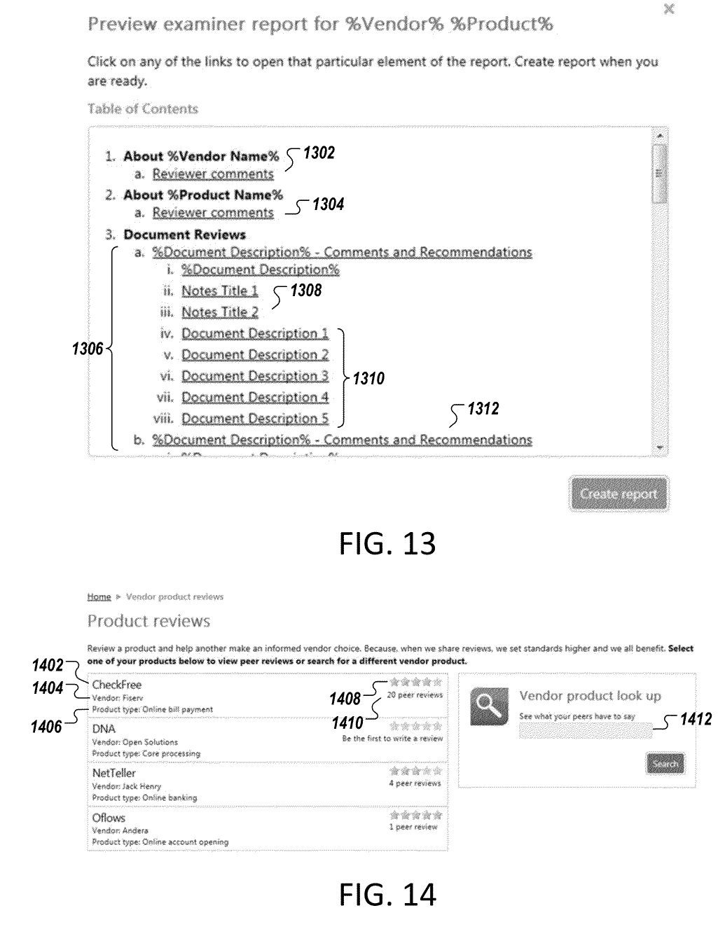

Still looking at FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an embodiment of the invention (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section to which the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (in the case of an annual report). The notification may be sent, for example, 9 months after the examination report has been generated.

Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

FIG. 14 is an example workspace 1400 to review vendor products in accordance with an embodiment of the invention. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value 1408, and an indication of the number of reviews (1410). In some implementations, the system 100 may provide a search tool 1412. In some implementations, the system 100 may also provide a rating/review module for a given vendor.

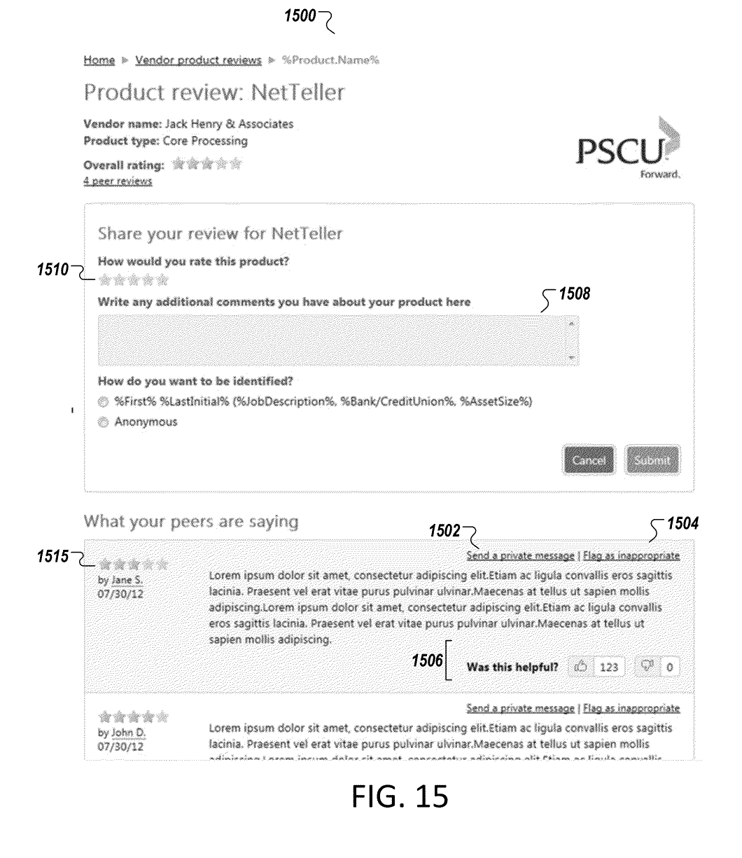

FIG. 15 is an example display 1500 for viewing product reviews in accordance with an embodiment of the invention. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

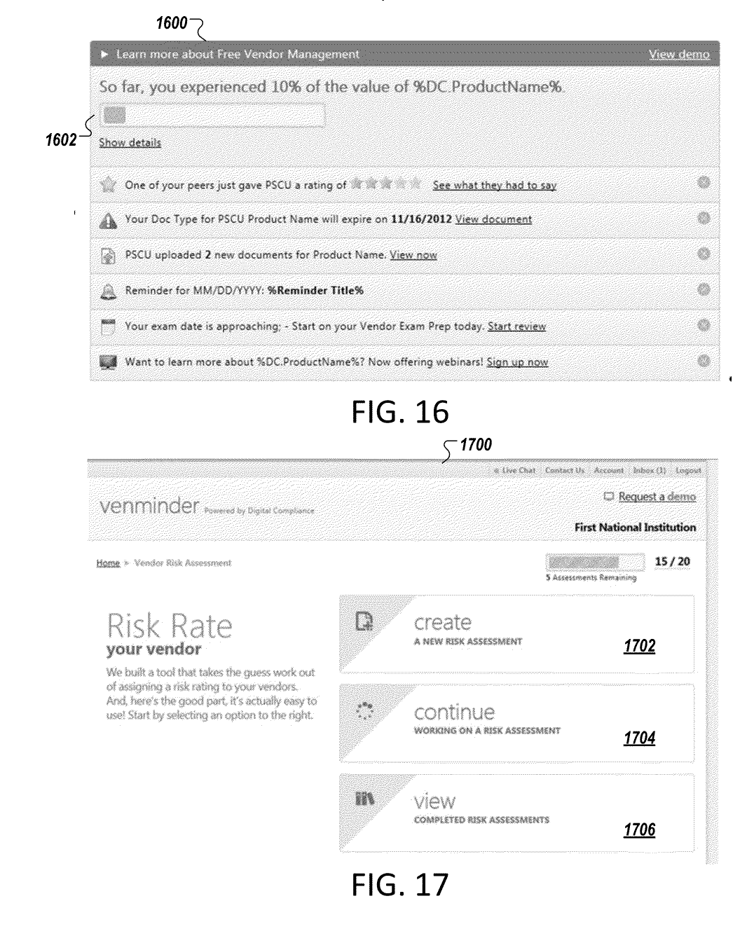

FIG. 16 is an example alert and information display 1600 in accordance with an embodiment of the invention. The display 1600 may include an experience bar 1602 that shows a given user's level of experience with the system 100. The system 100 may calculate the experience bar based on a set of tasks or functions performed by the end-user within the system 100. Each function may be assigned a function value, which may be aggregated to produce a total experience value. The experience bar 1602 may display the total experience value to the user. Examples of assigned values for a set of functions are provided in Table 4.

TABLE 4

| Function | Link | Percentage |
|---|---|---|
| Add Contract | Upload Contract | 10% |
| Add 2 Compliance Documents | Document Storage | 5% each |
| Add a vendor product | Add Vendor Product | 10% |
| Add a collaborator | Vendor Dashboard | 10% |
| Attach an email and Note | Emails and Notes | 5% each |
| Add a reminder | Reminders | 10% |
| Preform Exam Prep | Exam Prep | 20% |
| Write a review | Vendor Product Review | 10% |

Risk-assessment Module

In another aspect of an embodiment, the system 100 provides a risk-assessment module 214 that may allow the end-user to rate the vendor products and/or vendors in the areas of Information Access, Operational and Financial Dependency and Regulatory Exposure. To this end, the system 100 may provide a graphical user interface configured to display one or more prompts for user entries associated with a risk assessment of a given vendor product where the user entry are in response to a set of questionnaires.

In some implementations, the system 100 stores libraries of pre-defined questionnaires that the end-user can search. In some implementations, the libraries may be defined for a given financial institution. To this end, the libraries may be accessible to end-user associated with the financial institutions. Once a template questionnaire is selected and displayed, the system 100 may allow the end-user to add questions to the template questionnaires. The questionnaires are used to solicit a risk rating about an aspect of the product. The ratings may be aggregated to provide an aggregated risk rating for the product. The aggregated risk rating may be employed in the examination preparation and examination report.

FIG. 17 is an example workspace 1700 for performing a risk assessment of a vendor product in accordance with an embodiment of the invention. The workspace 1700 provide prompts for a user to create a new risk assessment (1702), to continue work on a risk assessment that is in progress (1704), and to view a completed risk assessment (1706).

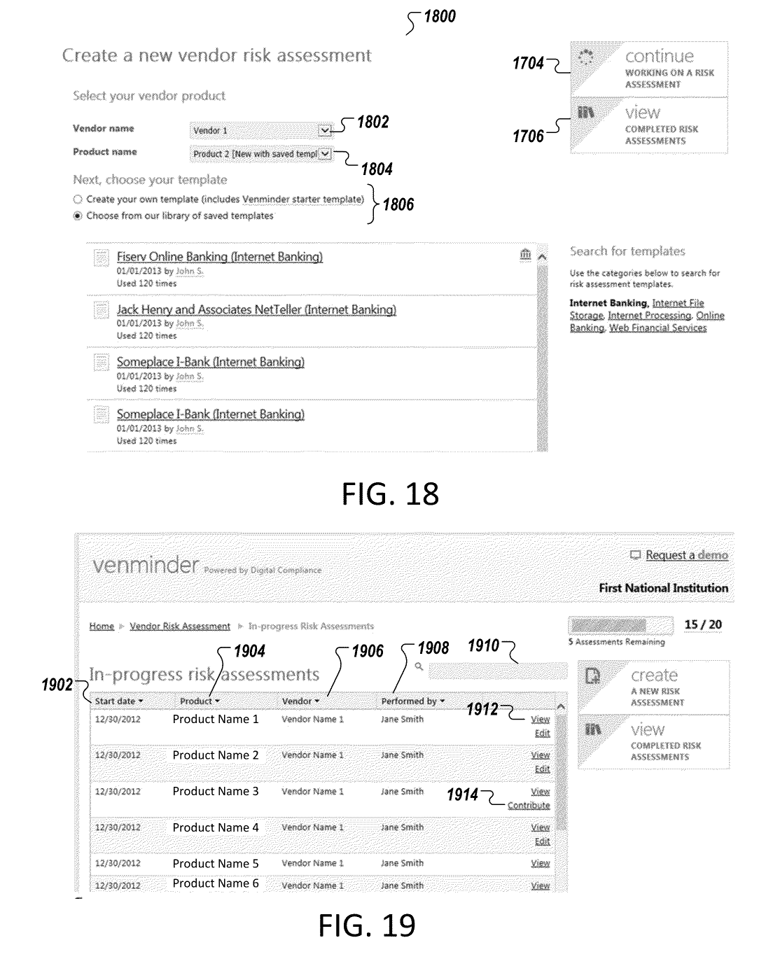

FIG. 18 is an example workspace 1800 to initiate a new risk assessment of a vendor product in accordance with an embodiment of the invention. The workspace 1800 may include a prompt for a vendor name (1802) and a product name (1804).

In some implementations, the system 100 may maintain a list of existing and completed risk assessment. The system 100 may determine whether a request to initiate the risk assessment for the given vendor product is a duplicate of an existing risk-assessment evaluation or a completed risk-assessment evaluation. To this end, the system 100 may use the list to prevent duplicate risk-assessment evaluations from being initiated for a given vendor product for a given end-user and financial institution.

The workspace 1800 may provide the end-user with a prompt (1806) to start i) a new template for a given risk area (e.g., Information Access, Operational and Financial Dependency and Regulatory Exposure), ii) a template used by the end-user the last time a risk assessment was performed, and iii) a template created by other end-users that is accessible to the end-user.

FIG. 19 is an example workspace 1900 to view risk-assessment evaluations that are in-progress in accordance with an embodiment of the invention. The workspace 1900 may display all of the risk-assessment evaluations of vendor products that are currently in-progress by a given financial institution. The workspace 1900 may display a start date associated with a given risk-assessment evaluation (1902), a product name (1904), a vendor name (1906), and an identifier of the end-user that initiated the risk-assessment evaluation (1908). The workspace 1900 may also allow the end-user to view an identifier of other end-users that may edit a risk assessment or have viewing permission of the risk assessment results (1912). The workspace 1900 may also allow the end-user to invite other end-user/product managers to contribute to a given risk-assessment evaluation (1914).

In some implementations, the workspace 1900 may include a search tool 1910 for searching of the vendor or products.

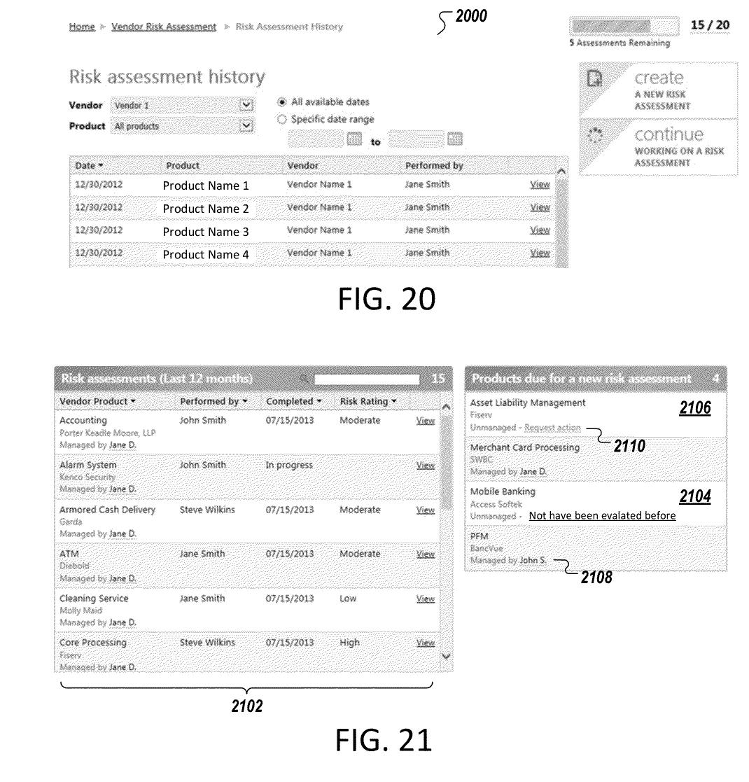

FIG. 20 is an example workspace 2000 to view completed risk-assessment evaluations in accordance with an embodiment of the invention. The workspace 2000 allows an end-user to view a list of all of the completed risk assessments by a given financial institution for a given product or vendor. The workspace 2000 allows the end-user to search for past evaluations, for example, based on the vendor name, the product name, and date that the assessment was initiated or completed.

FIG. 21 is an example dashboard 2100 to manage risk-assessment evaluations of vendors and vendor products in accordance with an embodiment of the invention. In some implementations, the dashboard 2100 may display a summary of risk assessments that are in-progress or have been completed (2102) within the last 12 months. The dashboard 2100 may display a list of vendor products that have never had a risk assessment completed (2104). The dashboard 2100 may display a list of vendor products that are due for a risk assessment (2106) (for example, the product had an assessment performed and/or completed in the past).

The dashboard 2100 may display owners (2108) of risk assessment projects and whether a given risk assessment has not been assigned (2110).

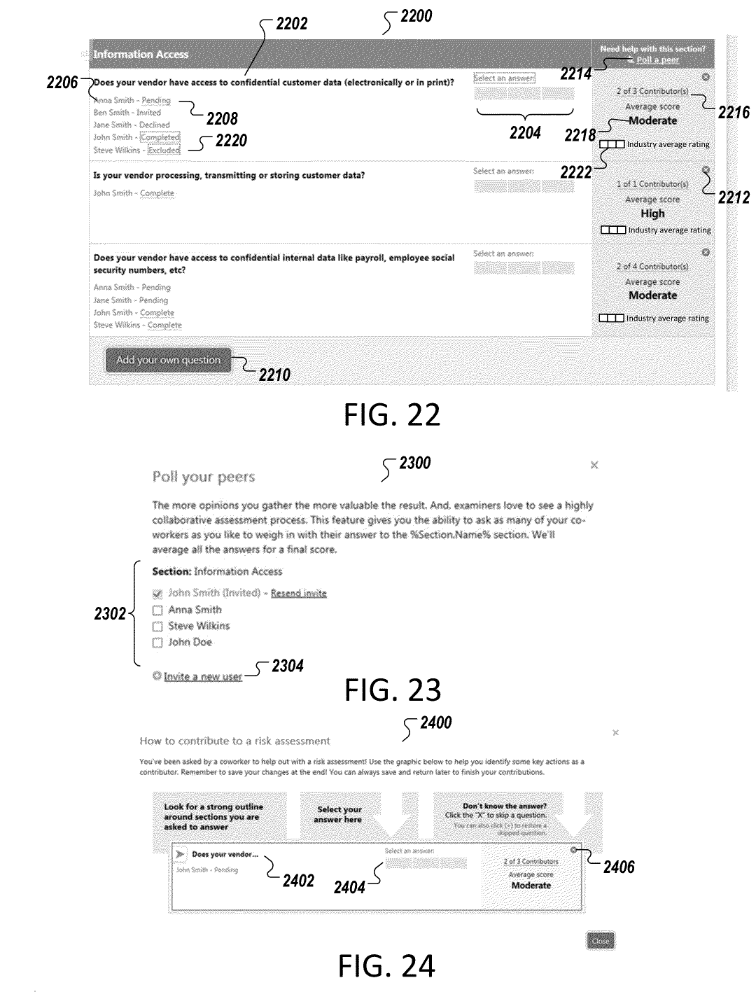

FIG. 22 is an example risk assessment workspace 2200 in accordance with an embodiment of the invention. The workspace 2200 may display a set of questions (2202) and a prompt (2204) for the end-user to select a reply, which may consist of a risk level rating (e.g., low, moderate, high). In some implementations, the workspace 2200 may include prompts (2214) to allow the end-user to invite or poll one or more peers to contribute to the evaluation/assessment.

The workspace 2200 may display a summary rating (2218) for each of the risk assessment questions. The summary rating may be an average (i.e., mean), a mode, or a weighted sum (in which certain “expert” collaborators are assigned higher weights). In some implementations, the workspace 2200 may display a list of collaborators (2206) and their progress in providing their comments (2208). The workspace 2200 may provide a prompt (2216) for the end-user to see individual feedback or input from a given peer or collaborator. In some implementations, the workspace 2200 may allow the end-user to exclude certain peer evaluations from the summary rating (2220). In some implementations, the end-user may include or exclude a certain peer evaluation by selecting the displayed status (e.g., 2220). The workspace 2200 may display an industry rating (2222) for a given vendor product.

The workspace 2200 may include prompts to allow the end-user to add additional questions to the workspace (2210) or remove questions from the workspace (2212).

Upon selection of the prompt to invite or poll a set of peers to contribute to the evaluation/assessment (2214), the system 100 may provide a list of peers for the end-user to select. FIG. 23 is an example invitation-workspace 2300 to invite peers to contribute to a risk-assessment evaluation in accordance with an embodiment of the invention. The workspace 2300 may include a list 2302 of peers who are registered (i.e., another end-user) with the system 100. The workspace 2300 may provide a prompt (2304) for contact information for a new user.

FIG. 24 is an example request message 2400 for comments from a collaborator to a given risk-assessment evaluation in accordance with an embodiment of the invention. The request message 2400 may display the question (2402) as presented in the risk-assessment evaluation and a prompt (2404) for a reply. The request message 2400 may also provide a prompt (2406) to decline to provide a response and/or feedback.

In another aspect of the disclosure, a business model is provided for securing subscriptions from financial institutions for a financial institution/vendor relationship management system. For example, free online tools are offered for vendors to use to securely distribute their sensitive compliance documentation to financial institution clients in a vendor-controlled fashion. When vendors distribute compliance documents through the system, they invite their financial institutions to use the system to retrieve them (also free of charge to the financial institution). The financial institution is given an opportunity to use the system to manage one or more of their vendor products, including a certain amount of storage space. The financial institutions can then upgrade online to various individual user-based packages by credit card, or a system for enterprise-wide, more extensive usage. The enterprise package may be sold to a financial institution, where storage space is shared across the institution, and high volumes of vendor products, contracts, etc. can be managed. The enterprise package may also provide the institution with an unlimited number of users accessing the system. The package may provide the financial institution with administrative controls and executive-level dashboard. Examples of such subscriptions and online tools are provided in Appendices B-D and G of the U.S. Provisional Patent Application No. 61/805,066, which is incorporated herein by reference in its entirety.

In another example, as shown in FIGS. 19-20, the system 100, in some implementations, provides a pre-defined number of complimentary risk assessments for vendors and/or products that a given end-user or financial institution may perform. The system 100 may display a number of remaining complimentary risk assessments to promote an end-user to evaluate and use the tool.

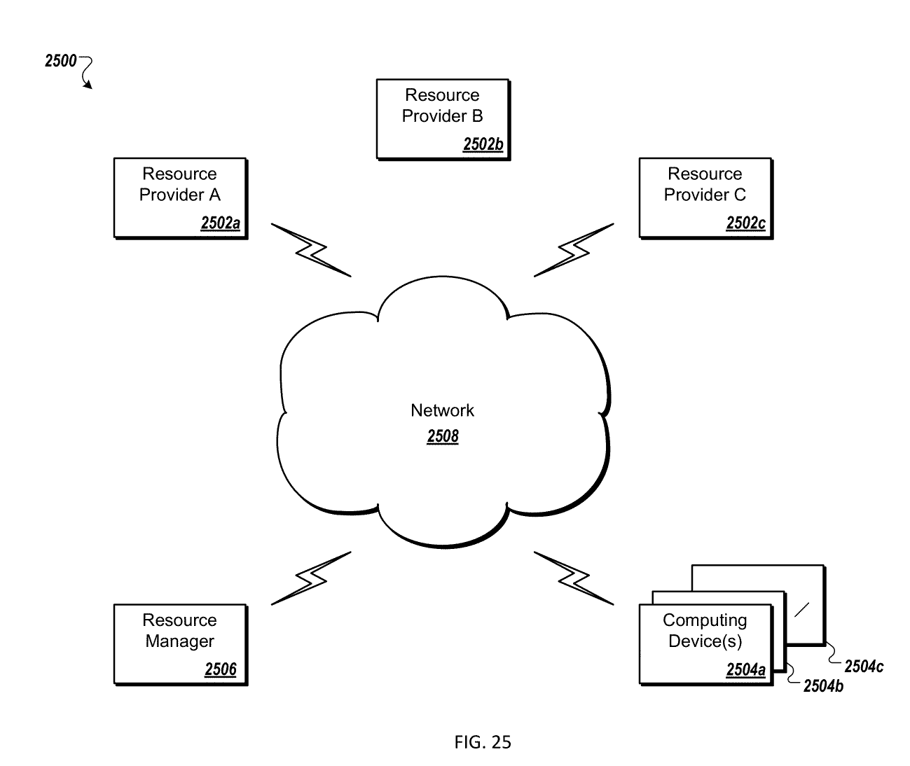

FIG. 25 shows an implementation of a network environment 2500 for use in the systems, methods, and apparatus for managing contracts between a financial institution and its vendors, for preparation of associated vendor oversight reports, and for securing subscriptions for a financial institution/vendor relationship management system, described herein. In brief overview, referring now to FIG. 25, a block diagram of an exemplary cloud computing environment 2500 is shown and described. The cloud computing environment 2500 may include one or more resource providers 2502a, 2502b, 2502c (collectively, 2502). Each resource provider 2502 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 2502 may be connected to any other resource provider 2502 in the cloud computing environment 2500. In some implementations, the resource providers 2502 may be connected over a computer network 2508. Each resource provider 2502 may be connected to one or more computing device 2504a, 2504b, 2504c (collectively, 2504), over the computer network 2508.

The cloud computing environment 2500 may include a resource manager 2506. The resource manager 2506 may be connected to the resource providers 2502 and the computing devices 2504 over the computer network 2508. In some implementations, the resource manager 2506 may facilitate the provision of computing resources by one or more resource providers 2502 to one or more computing devices 2504. The resource manager 2506 may receive a request for a computing resource from a particular computing device 2504. The resource manager 2506 may identify one or more resource providers 2502 capable of providing the computing resource requested by the computing device 2504. The resource manager 2506 may select a resource provider 2502 to provide the computing resource. The resource manager 2506 may facilitate a connection between the resource provider 2502 and a particular computing device 2504. In some implementations, the resource manager 2506 may establish a connection between a particular resource provider 2502 and a particular computing device 2504. In some implementations, the resource manager 2506 may redirect a particular computing device 2504 to a particular resource provider 2502 with the requested computing resource.

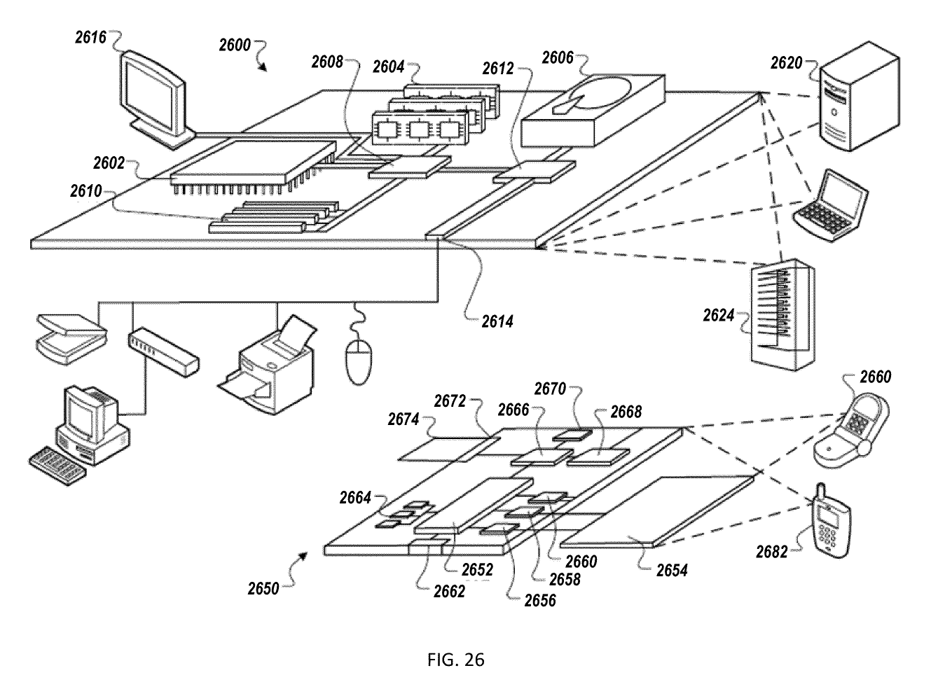

FIG. 26 shows an example of a computing device 2600 and a mobile computing device 2650 that can be used to implement the techniques described in this disclosure. The computing device 2600 is intended to represent various forms of digital computers, such as laptops, desktops, workstations, personal digital assistants, servers, blade servers, mainframes, and other appropriate computers. The mobile computing device 2650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 2600 includes a processor 2602, a memory 2604, a storage device 2606, a high-speed interface 2608 connecting to the memory 2604 and multiple high-speed expansion ports 2610, and a low-speed interface 2612 connecting to a low-speed expansion port 2614 and the storage device 2606. Each of the processor 2602, the memory 2604, the storage device 2606, the high-speed interface 2608, the high-speed expansion ports 2610, and the low-speed interface 2612, are interconnected using various busses, and may be mounted on a common motherboard or in other manners as appropriate. The processor 2602 can process instructions for execution within the computing device 2600, including instructions stored in the memory 2604 or on the storage device 2606 to display graphical information for a GUI on an external input/output device, such as a display 2616 coupled to the high-speed interface 2608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 2604 stores information within the computing device 2600. In some implementations, the memory 2604 is a volatile memory unit or units. In some implementations, the memory 2604 is a non-volatile memory unit or units. The memory 2604 may also be another form of computer-readable medium, such as a magnetic or optical disk.

The storage device 2606 is capable of providing mass storage for the computing device 2600. In some implementations, the storage device 2606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 2602), perform one or more methods, such as those described above. The instructions can also be stored by one or more storage devices such as computer- or machine-readable mediums (for example, the memory 2604, the storage device 2606, or memory on the processor 2602).

The high-speed interface 2608 manages bandwidth-intensive operations for the computing device 2600, while the low-speed interface 2612 manages lower bandwidth-intensive operations. Such allocation of functions is an example only. In some implementations, the high-speed interface 2608 is coupled to the memory 2604, the display 2616 (e.g., through a graphics processor or accelerator), and to the high-speed expansion ports 2610, which may accept various expansion cards (not shown). In the implementation, the low-speed interface 2612 is coupled to the storage device 2606 and the low-speed expansion port 2614. The low-speed expansion port 2614, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 2600 may be implemented in a number of different forms, as shown in the figure. For example, it may be implemented as a standard server 2620, or multiple times in a group of such servers. In addition, it may be implemented in a personal computer such as a laptop computer 2622. It may also be implemented as part of a rack server system 2624. Alternatively, components from the computing device 2600 may be combined with other components in a mobile device (not shown), such as a mobile computing device 2650. Each of such devices may contain one or more of the computing device 2600 and the mobile computing device 2650, and an entire system may be made up of multiple computing devices communicating with each other.

The mobile computing device 2650 includes a processor 2652, a memory 2664, an input/output device such as a display 2654, a communication interface 2666, and a transceiver 2668, among other components. The mobile computing device 2650 may also be provided with a storage device, such as a micro-drive or other device, to provide additional storage. Each of the processor 2652, the memory 2664, the display 2654, the communication interface 2666, and the transceiver 2668, are interconnected using various buses, and several of the components may be mounted on a common motherboard or in other manners as appropriate.

The processor 2652 can execute instructions within the mobile computing device 2650, including instructions stored in the memory 2664. The processor 2652 may be implemented as a chipset of chips that include separate and multiple analog and digital processors. The processor 2652 may provide, for example, for coordination of the other components of the mobile computing device 2650, such as control of user interfaces, applications run by the mobile computing device 2650, and wireless communication by the mobile computing device 2650.

The processor 2652 may communicate with a user through a control interface 2658 and a display interface 2656 coupled to the display 2654. The display 2654 may be, for example, a TFT (Thin-Film-Transistor Liquid Crystal Display) display or an OLED (Organic Light Emitting Diode) display, or other appropriate display technology. The display interface 2656 may comprise appropriate circuitry for driving the display 2654 to present graphical and other information to a user. The control interface 2658 may receive commands from a user and convert them for submission to the processor 2652. In addition, an external interface 2662 may provide communication with the processor 2652, so as to enable near area communication of the mobile computing device 2650 with other devices. The external interface 2662 may provide, for example, for wired communication in some implementations, or for wireless communication in other implementations, and multiple interfaces may also be used.

The memory 2664 stores information within the mobile computing device 2650. The memory 2664 can be implemented as one or more of a computer-readable medium or media, a volatile memory unit or units, or a non-volatile memory unit or units. An expansion memory 2674 may also be provided and connected to the mobile computing device 2650 through an expansion interface 2672, which may include, for example, a SIMM (Single In Line Memory Module) card interface. The expansion memory 2674 may provide extra storage space for the mobile computing device 2650, or may also store applications or other information for the mobile computing device 2650. Specifically, the expansion memory 2674 may include instructions to carry out or supplement the processes described above, and may include secure information also. Thus, for example, the expansion memory 2674 may be provided as a security module for the mobile computing device 2650, and may be programmed with instructions that permit secure use of the mobile computing device 2650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 2652), perform one or more methods, such as those described above. The instructions can also be stored by one or more storage devices, such as one or more computer- or machine-readable mediums (for example, the memory 2664, the expansion memory 2674, or memory on the processor 2652). In some implementations, the instructions can be received in a propagated signal, for example, over the transceiver 2668 or the external interface 2662.

The mobile computing device 2650 may communicate wirelessly through the communication interface 2666, which may include digital signal processing circuitry where necessary. The communication interface 2666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 2668 using a radio-frequency. In addition, short-range communication may occur, such as using a Bluetooth®, Wi-Fi™, or other such transceiver (not shown). In addition, a GPS (Global Positioning System) receiver module 2670 may provide additional navigation- and location-related wireless data to the mobile computing device 2650, which may be used as appropriate by applications running on the mobile computing device 2650.

The mobile computing device 2650 may also communicate audibly using an audio codec 2660, which may receive spoken information from a user and convert it to usable digital information. The audio codec 2660 may likewise generate audible sound for a user, such as through a speaker, e.g., in a handset of the mobile computing device 2650. Such sound may include sound from voice telephone calls, may include recorded sound (e.g., voice messages, music files, etc.) and may also include sound generated by applications operating on the mobile computing device 2650.

The mobile computing device 2650 may be implemented in a number of different forms, as shown in the figure. For example, it may be implemented as a cellular telephone 2680. It may also be implemented as part of a smart-phone 2682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

In view of the structure, functions and apparatus of the systems and methods described here, in some implementations, a systems, methods, and apparatus for managing contracts between a financial institution and its vendors, for preparation of associated vendor oversight reports, and for securing subscriptions for a financial institution/vendor relationship management system are provided. Having described certain implementations of methods, systems, and apparatus herein, it will now become apparent to one of skill in the art that other implementations incorporating the concepts of the disclosure may be used. Therefore, the disclosure should not be limited to certain implementations, but rather should be limited only by the spirit and scope of the following claims.

What is claimed is:

1. A computer-implemented method for managing contracts between a financial institution and its vendors, the method comprising the steps of:
(a) providing, by a processor of a computing device, a first graphical user interface configured to display, for a given financial institution, a listing of vendor products and, upon selection of a listed vendor product by a user, to display details regarding the selected vendor product;
(b) providing, by the processor, a second graphical user interface configured to facilitate uploading, by the user, of one or more contracts associated with the selected vendor product;
(c) providing, by the processor, a third graphical user interface configured to guide a user in preparation of a vendor oversight report associated with the selected vendor product; and
(d) displaying, by the processor, a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

2. The method of claim 1, comprising determining, by the processor, whether one or more uploaded contracts associated with the selected vendor product has an upcoming critical date, activating an alert if a threshold in relation to the critical date and current date is met, and displaying an alert widget corresponding to the activated alert.

3. The method of claim 1, comprising providing, by the processor, a graphical user interface configured to display one or more prompts for user entry of one or more of the following items corresponding to a selected vendor product or an associated uploaded contract: a contract renewal deadline, a vendor benchmark, a risk rating, a performance rating, a performance comment, a status, and contact information of a collaborator.

4. The method of claim 3, wherein the one or more items prompted for user entry comprises a performance rating and a performance comment associated with the selected vendor product, wherein the entered performance rating is received anonymously and is compiled in a set of performance ratings received for the given vendor product by a plurality of users, wherein the method comprises displaying at least one of a composite performance rating and a listing of one or more performance comments received from users of the given vendor product.

5. The method of claim 4, further comprising displaying, by the processor, the at least one composite performance rating and the listing of one or more performance comments received from users of the given vendor product and one or more corresponding products provided by one or more different vendors.

6. The method of claim 5, further comprising displaying, by the processor, one or more of the following corresponding to a given performance comment: a “like” prompt, a “dislike” prompt, a flag to identify inappropriate content.

7. The method of claim 6, wherein the method comprises displaying a listing of a plurality of performance comments received from users of the given vendor product, wherein the listing is ordered on the graphical user interface according to popularity.

8. The method of claim 1, comprising providing a graphical communication portal allowing a user to anonymously solicit a textual message regarding a given vendor product by the vendor and to anonymously solicit a textual message regarding a given performance rating or performance comment by the user who provided the given performance rating or performance comment.

9. The method of claim 1, comprising storing the one or more contracts and other documents associated with the selected vendor product, and displaying icons and text corresponding to a set of folders for organizing the documents associated with the selected vendor product.

10. The method of claim 9, wherein the set of folders for organizing the documents associated with the selected vendor product comprises a compliance document folder with text indicating it contains compliance documents.

11. The method of claim 10, wherein selection by the user of the compliance document folder results in presentation, by the processor, of a set of subfolders, wherein the set of subfolders comprises text indicating one or more of the following categories: Audit/IT, Business Continuity, Financial, Insurance, Miscellaneous, Policy, and Product Management.

12. The method of claim 3, wherein the one or more items prompted for user entry comprises contact information of one or more collaborators for the selected vendor product.

13. The method of claim 12, comprising restricting access to stored documents and other information regarding the selected vendor product, and restricting ability to upload documents and other information pertaining to the selected vendor product, to a group of collaborators at a given financial institution named for that vendor product.

14. The method of claim 1, wherein step (c) comprises providing, by the processor, a guided workflow configured to guide a user in preparation of a vendor oversight report associated with the selected vendor product, wherein the guided workflow comprises a series of widgets prompting entry or upload of one or more of the following:
(i) the risk level associated with the selected vendor product;
(ii) a date of next regulatory exam;
(iii) a selection of one or more agencies that is applicable to the financial institution user;
(iv) documents for use in preparation of the vendor oversight report;
(v) textual commentary regarding the selected vendor product and the vendor of the selected vendor product;
(vi) a request for assistance.

15. The method of claim 14, wherein the guided workflow displays a current status of the vendor oversight report associated with the selected vendor product.

16. The method of claim 14, wherein the guided workflow displays a visual checklist of documents the financial institution has received from the vendor regarding the selected vendor product, and documents remaining to be obtained from the vendor prior to completion of the vendor oversight report associated with the selected vendor product.

17. The method of claim 1, wherein the method is a computer-implemented method for managing contracts between a financial institution and its vendors and for preparation of associated vendor oversight reports as part of a financial institution/vendor relationship management system.

18. The method of claim 1, comprising providing, by the processor, a graphical user interface configured to display one or more prompts for user entry associated with a risk assessment of a given vendor product, wherein the user entry are in response to a set of questionnaires.

19. The method of claim 18, the method comprises:
determining, by the processor, whether a request to initiate risk assessment for the given vendor product is a duplicate of an existing risk-assessment evaluation or a completed risk-assessment evaluation; and
preventing, by the processor, the request from initiating a new risk-assessment evaluation.

20. The method of claim 19, wherein the graphical user interface displays all of the existing risk-assessment evaluation and the completed risk-assessment evaluation performed by a given organization associated to an end-user.

21. The method of claim 19, wherein the graphical user interface displays a first list of vendor products having never had a risk assessment completed, a second list of vendor products having an annual risk assessment due, and a third list of vendor products that are currently being assessed or have been completed one year before.

22. A financial institution/vendor relationship management system for managing contracts between a financial institution and its vendors and for preparation of associated vendor oversight reports, the system comprising:
a data management module configured to store data pertaining to a set of vendor products for a financial institution, said data accessible by a computing device, the computing device comprising:
a processor; and
a non-transitory computer readable medium storing instructions thereon, wherein the instructions, when executed, cause the processor to:
(a) provide a first graphical user interface to display on the computing device, for a given financial institution, a listing of vendor products and, upon selection of a listed vendor product by a user via the computing device, to display details regarding the selected vendor product;
(b) provide a second graphical user interface on the computing device to facilitate uploading, by the user, of one or more contracts associated with the selected vendor product via the computing device;
(c) provide a third graphical user interface on the computing device to guide a user in preparation of a vendor oversight report associated with the selected vendor product; and
(d) display on the computing device a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

23. A method for securing subscriptions for a financial institution/vendor relationship management system for managing contracts between a financial institution and its vendors and for preparation of associated vendor oversight reports, the method comprising the steps of:
(a) providing, by a processor of a computing device, a web-based graphical user interface that facilitates uploading by a vendor of compliance documentation;
(b) displaying, by the processor, one or more widgets prompting secure upload of compliance documents associated with a given vendor product owned by a financial institution identified by the vendor and prompting entry, by the vendor, of one or more of: (i) compliance data, and (ii) financial institution contact information associated with the given vendor product; and
(c) sending, by the processor, an email notification to the financial institution identified by the vendor that compliance data and compliance documents have been uploaded by the vendor, wherein the email notification comprises an invitation to the financial institution to enter into a subscription to retrieve the uploaded data and documents via the relationship management system.

24. The method of claim 23, further comprising displaying, by the processor, an invitation to a user at the financial institution an offer to upgrade the subscription, where an initial subscription is free, and an upgrade is available to manage more than one vendor product and to expand available storage space for archival of the uploaded data and documents corresponding to a vendor product.
